(19) United States
(12) Patent Application Publication
(10) Pub. No.: US 2026/0205225 A1
(43) Pub. Date: Jul. 16, 2026

(54) WIRELESS COMMUNICATIONS FOR PROVIDING A BLIND ASSISTANCE SERVICE

(71) Applicant: Lenovo (Singapore) Pte. Ltd., Singapore (SG)

(72) Inventors: Sheeba Backia Mary Baskaran, Friedrichsdorf (DE); Prateek Basu Mallick, Dreieich (DE); Andreas Kunz, Ladenburg (DE)

(21) Appl. No.: 19/168,209

(22) PCT Filed: Mar. 27, 2024
(86) PCT No.: PCT/IB2024/052989

§ 371 Date: Sep. 23, 2025

Related U.S. Application Data
(60) Provisional application No. 63/492,270, filed on Mar. 27, 2023.

(51) Int. Cl. H04L 1/00; H04W 8/22; H04W 12/06; H04W 84/06

(52) U.S. Cl. CPC H04L 1/0038; H04W 8/22; H04W 12/06; H04W 84/06

(57) ABSTRACT

Apparatuses, methods, and systems are disclosed for wireless communication, including wireless communications for providing a blind assistance service. One method includes receiving, from a blind assistance device, a service request indication associated with a blind assistance service. The method includes determining an availability of a subscription to the blind Begin assistance service. The method includes transmitting a pairing authorization request to a NF for the blind assistance service.

### FIELD

The subject matter disclosed herein relates generally to wireless communications and more particularly relates to wireless communications for providing a blind assistance service.

### BACKGROUND

A wireless communications system may include one or multiple network communication devices, such as base stations, which may be otherwise known as an eNodeB (“eNB”), a next-generation NodeB (“gNB”), or other suitable terminology. Each network communication devices, such as a base station may support wireless communications for one or multiple user communication devices, which may be otherwise known as user equipment (“UE”), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (“3G”) radio access technology, fourth generation (“4G”) radio access technology, fifth generation (“5G”) radio access technology, among other suitable radio access technologies beyond 5G (e.g., sixth generation (“6G”)).

The wireless communications systems may also support communication between UEs. In some cases, wireless communications systems may not enable communication between certain types of UEs.

### BRIEF SUMMARY

Methods for wireless communications for providing a blind assistance service are disclosed. Apparatuses and systems also perform the functions of the methods. One embodiment of a method includes receiving, from a blind assistance device, a service request indication associated with a blind assistance service. In some embodiments, the method includes determining an availability of a subscription to the blind assistance service. In certain embodiments, the method includes transmitting a pairing authorization request to a NF for the blind assistance service.

One apparatus for wireless communications for providing a blind assistance service includes a processor. In some embodiments, the apparatus includes a memory coupled to the processor, the memory including instructions executable by the processor to cause the apparatus to: receive, from a blind assistance device, a service request indication associated with a blind assistance service; determine an availability of a subscription to the blind assistance service; and transmit a pairing authorization request to a NF for the blind assistance service.

Another embodiment of a method for wireless communications for providing a blind assistance service includes transmitting, to a core network device, a service request indication associated with a blind assistance service. In some embodiments, the method includes receiving, from the core network device, a response to the service request indication, the response including a blind assistance service authorization result.

Another apparatus for wireless communications for providing a blind assistance service includes a processor. In some embodiments, the apparatus includes a memory coupled to the processor, the memory including instructions executable by the processor to cause the apparatus to: transmit, to a core network device, a service request indication associated with a blind assistance service; and receive, from the core network device, a response to the service request indication, the response including a blind assistance service authorization result.

### BRIEF DESCRIPTION OF THE DRAWINGS

FIG. 1 illustrates an example of a wireless communications system that supports wireless communications for providing a blind assistance service in accordance with aspects of the present disclosure.

FIG. 2 illustrates an example of an apparatus that supports wireless communications for providing a blind assistance service in accordance with aspects of the present disclosure.

FIG. 3 illustrates an example of an apparatus that supports wireless communications for providing a blind assistance service in accordance with aspects of the present disclosure.

FIG. 4 illustrates an example of a system that supports a uncrewed aerial system (“UAS”) service supplier (“USS”) uncrewed aerial vehicle (“UAV”) authorization and/or authentication (“UUAA”) procedure at protocol data unit (“PDU”) session establishment in accordance with aspects of the present disclosure.

FIG. 5 illustrates an example of a system that supports UAV pairing authorization during PDU session establishment in accordance with aspects of the present disclosure.

FIG. 6 illustrates an example of a system that supports UAV authorization by a USS and/or an uncrewed aerial system traffic management (“UTM”) for blind assistance service provision over over a third generation partnership project (“3GPP”) network in accordance with aspects of the present disclosure.

FIG. 7 illustrates an example of a system that supports UE and UAV pairing authorization by a USS and/or a uncrewed aerial system traffic management (“UTM”) for blind assistance service provision over a 3GPP network.

FIG. 8 illustrates a flow chart of a method that supports wireless communications for providing a blind assistance service in accordance with aspects of the present disclosure.

FIG. 9 illustrates a flow chart of another method that supports wireless communications for providing a blind assistance service in accordance with aspects of the present disclosure.

### DETAILED DESCRIPTION

A wireless communications system may include multiple communication devices, including network communication devices and user communication devices, which may support wireless communication in the wireless communications system. For example, the network communication devices and the user communication devices may support one or multiple radio access technologies including 4G, 5G, and radio access technologies beyond 5G (e.g., 6G). The wireless communications system may also support sidelink (“SL”) communications between multiple user communication devices (e.g., UEs). Examples of SL communications may include, but is not limited to, device-to-device (D2D) communications, vehicle-based communications, such as vehicle-to-vehicle (V2V) communications, vehicle-to-everything (V2X) communications, etc. As demand for communication high efficiency, high reliability, and low latency increases, it may be desirable for the wireless communications system, including the network communication devices and the user communication devices to support improvements to resource management for SL communications.

Various aspects of the present disclosure relate to enabling a user communication device (e.g., a UE) to support wireless communication, such as enabling blind assistance services, and specifically communication between a blind assistance device (e.g., UE) and network devices. By performing communications between the blind assistance device and network devices, the blind assistance services may be enabled.

Aspects of the present disclosure are described in the context of a wireless communications system. Aspects of the present disclosure are further illustrated and described with reference to apparatus diagrams and flowcharts.

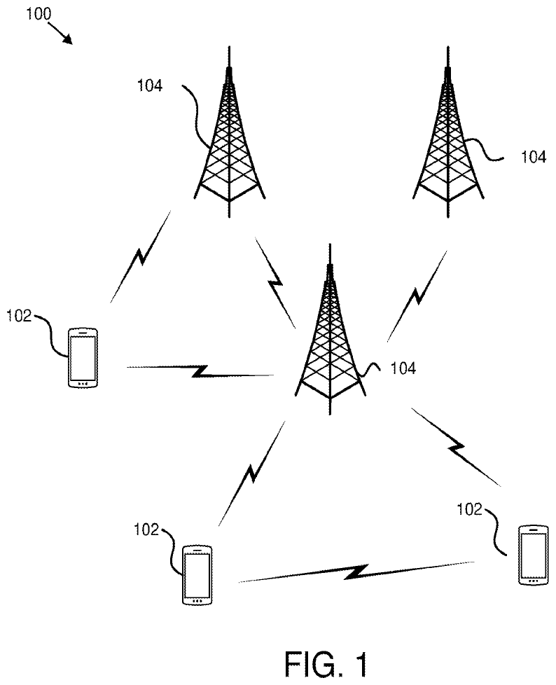

FIG. 1 illustrates an example of a wireless communications system 100 that supports wireless communications for providing a blind assistance service in accordance with aspects of the present disclosure. The wireless communication system 100 may include one or more remote units 102 and one or more network units 104. The wireless communications system 100 may support various radio access technologies. In some embodiments, the wireless communications system 100 may be a 4G network, such as an LTE network or an LTE-Advanced (LTE-A) network. In some other embodiments, the wireless communications system 100 may be a 5G network, such as an NR network. In other embodiments, the wireless communications system 100 may be a network beyond 5G. Additionally, even though a specific number of remote units 102 and network units 104 are depicted in FIG. 1, one of skill in the art will recognize that any number of remote units 102 and network units 104 may be included in the wireless communication system 100.

The one or more remote units 102 may be dispersed throughout a geographic region of the wireless communications system 100. A remote unit 102 may include or may be referred to as a UE, a computing device, such as a desktop computer, a laptop computer, a personal digital assistant (“PDA”), a tablet computer, a smartphone, a smart television (e.g., televisions connected to the Internet), a set-top box, a game console, a security system (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (“UL”) communication signals. In certain embodiments, the remote units 102 may communicate directly with other remote units 102 via SL communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-third generation partnership project (“3GPP”) gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (“OFDM”) modulation scheme on the downlink (“DL”) and the remote units 102 transmit on the UL using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, from a blind assistance device, a service request indication associated with a blind assistance service. In some embodiments, the network unit 104 may determine an availability of a subscription to the blind assistance service. In certain embodiments, the network unit 104 may transmit a pairing authorization request to a NF for the blind assistance service. Accordingly, the network unit 104 may be used for wireless communications for providing a blind assistance service.

In certain embodiments, a remote unit 102 may transmit, to a core network device, a service request indication associated with a blind assistance service. In some embodiments, the remote unit 102 may receive, from the core network device, a response to the service request indication, the response including a blind assistance service authorization result. Accordingly, the remote unit 102 may be used for wireless communications for providing a blind assistance service.

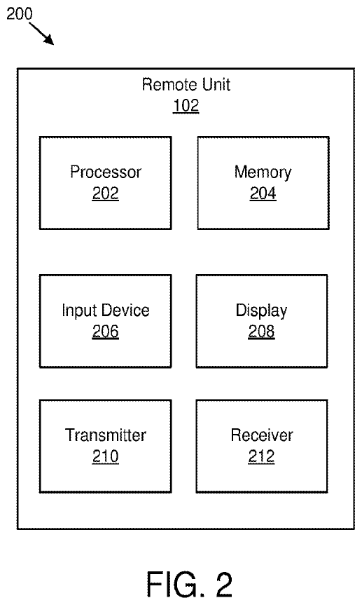

FIG. 2 illustrates an example of an apparatus 200 that supports wireless communications for providing a blind assistance service in accordance with aspects of the present disclosure. The apparatus 200 may be an example of a remote unit 102 as described herein. The remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In some embodiments, the memory 204 includes instructions executable by the processor 202 to cause the apparatus 200 to: transmit, to a core network device, a service request indication associated with a blind assistance service; and receive, from the core network device, a response to the service request indication, the response including a blind assistance service authorization result.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

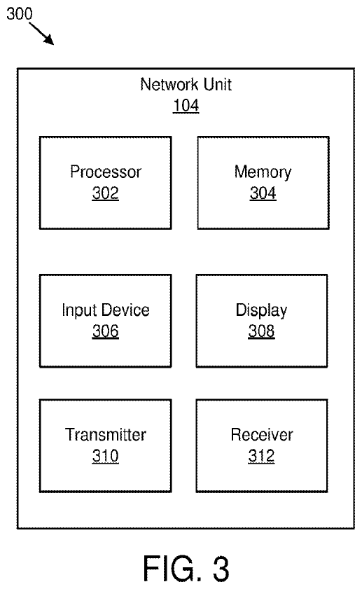

FIG. 3 illustrates an example of an apparatus that supports wireless communications for providing a blind assistance service in accordance with aspects of the present disclosure. The apparatus 300 may be an example of a network unit 104 as described herein. The network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the memory 304 includes instructions executable by the processor 302 to cause the apparatus 300 to: receive, from a blind assistance device, a service request indication associated with a blind assistance service; determine an availability of a subscription to the blind assistance service; and transmit a pairing authorization request to a NF for the blind assistance service.

It should be noted that one or more embodiments described herein may be combined into a single embodiment.

UAVs (such as drones) may be used for personal use to offer services to the visually impaired. Certain 3GPP communication systems (e.g., evolved packet system (“EPS”) and 5G system (“5GS”)) support UAS services for UAVs following a successful UAV USS authentication and authorization (“UUAA”) by allowing cases as requested by a UAV: 1) PDU session and/or protocol data network (“PDN”) connection establishment between USS and/or UTM and UAV to allow UAS data traffic and/or C2 data traffic; and 2) dedicated PDU session and/or PDN connection establishment between UAV and UAV-C to allow C2 data traffic.

Some 3GPP communication systems may not support UAVs being paired with any other devices such as wearables or blind assistance devices (e.g., for navigation support to visually impaired (e.g., blind)). So, if UAVs are deployed for blind assistance, such UAVs may not work over EPS and/or 5GS.

Do it yourself (“DIY”) drones may be a name given to amateur drones. DIY drones may be light and smaller, built for leisure, built for carrying a payload, and/or built for a variety of purposes such as photography or depth detection. Because of a global positioning system (“GPS”), internal video capabilities, and natural humming, drones may be developed to help the visually impaired to cross a city and/or to exercise. Such drones may be revolutionary for the blind community by reducing barriers to participate in traditional walking or exercise routines. In some systems, for drones to help blind people in their exercise program, a bracelet with a very small drone is attached to the wrist of the person. With verbal commands such as “navigate to the kitchen”, a GPS system built into the bracelet calculates a route and begins to fly. Using GPS and Bluetooth technology, the drone flies in front of the person, but remains within one meter of their presence. Using the drone as a guide, the person follows the sound to its destination. Once the goal is reached, a voice command returns the drone to the bracelet. In a lab environment, drones have been used to guide subjects in overcrowded rooms. Participants reached all targets without hitting walls, furniture, or other people with an integrated camera that can identify and avoid obstacles, guiding the user through the purring of rotors. The sound was easy to distinguish and allowed the subjects to walk as they normally would.

In some systems, 3GPP network related procedures enable UAVs to obtain UAV related services from a USS and/or UTM over the 3GPP network (e.g., via 4G EPS and 5GS). Moreover, a UAV may be paired with a UAV controller (“UAV-C”) to allow command and control (“C2”) traffic using the 4G and/or 5G communication network. C2 communication is a user plane link to deliver messages with information of command and control for UAV operation from a UAV controller, a UTM to a UAV, or to report telemetry data from a UAV to its UAV controller or a UTM.

Authorization for C2 may be required if a UAV establishes a user plane connection for C2 operations (e.g., to deliver messages with information of command and control for UAV operations from a UAV-C or USS to a UAV or to report telemetry data from a UAV to its UAV-C). Two sides of C2 communication (e.g., UAV and UAV-C) belong to the same UAS.

A UAV may be authorized by a USS to use a PDU Session and/or PDN connection for C2. Authorization for C2 may include the following: 1) UAV to UAV-C pairing authorization: authorization for pairing with a networked UAV-C or a UAV-C that connects to the UAV via Internet connectivity, before the UAV and the UAV-C can exchange C2 communication-one UAV can be paired with only one UAV-C at the any time-one UAV-C may be paired with one or more UAVs at the same time; and/or 2) flight authorization: authorization for flight when UAV also provides flight authorization information.

In various systems, C2 authorization may be carried out: 1) during a UUAA procedure (e.g., if UUAA is carried out at PDU session and/or PDN connection establishment) when the UAV requests establishment of a PDU session and/or PDN connection for connectivity; 2) during PDU session modification and/or UE requested bearer resource modification when the UAV requires to use an existing PDU session and/or PDN connection to exchange C2 communication related messages; and/or 3) during a new PDU session and/or PDN connection establishment if the UAV requires to use a separate PDU session and/or PDN connection for C2 communication.

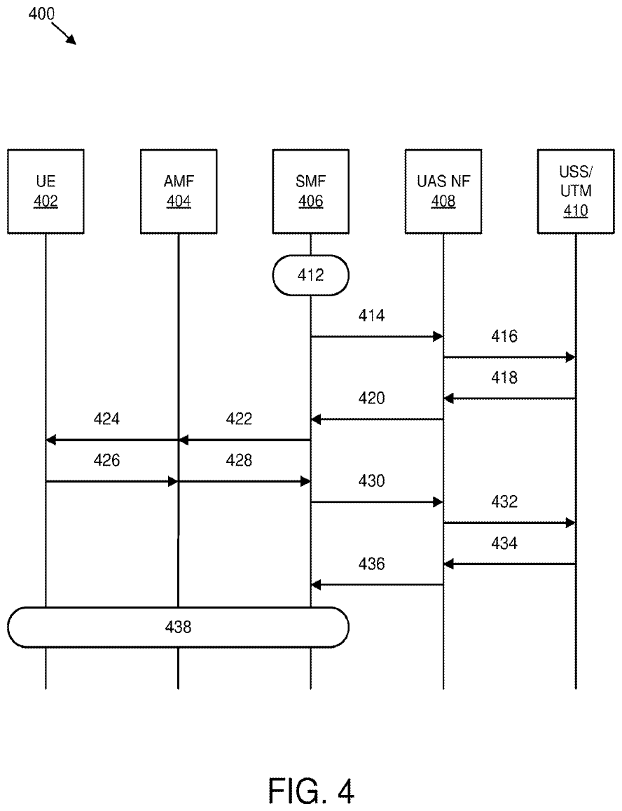

FIG. 4 illustrates an example of a system 400 that supports a UUAA procedure at PDU session establishment in accordance with aspects of the present disclosure. The system 400 includes a UE 402, an AMF 404, an SMF 406, a UAS NF 408, and a USS/UTM 410. Each of the communications in the system 400 may include one or more messages.

The SMF 406 (or the AMF 404) may trigger the UUAA procedure if the UAV has an aerial UE subscription and the UAV requests access to UAS services by providing the civil aviation administration (“CAA”) level (“CAA-Level”) UAV identifier (“ID”) of the UAV in the registration request or PDU session establishment request.

In a first communication 414, an Nnef_Auth_Req is transmitted. Moreover, in a second communication 416, an authenticate request is transmitted.

In a third communication 418, an authenticate response (e.g., authentication message) is transmitted. Further, in a fourth communication 420, an Nnef_Auth_Resp (e.g., authentication message) is transmitted. Moreover, in a fifth communication 422 and a sixth communication 424, a non-access stratum (“NAS”) mobility management (“MM”) transport (e.g., authentication message) is transmitted. In a seventh communication 426 and an eighth communication 428, an NAS MM transport (e.g., authentication message) is transmitted. Further, in a ninth communication 430, an Nnef_Auth_Req (e.g., authentication message) is transmitted. Moreover, in a tenth communication 432, an authenticate request (e.g., authentication message) is transmitted. It should be noted that there may be multiple round-trip messages subject to the authentication method used by the USS/UTM 410 (e.g., repetitions of the third communication 418 through the tenth communication 432).

In an eleventh communication 434, an authenticate response (e.g., authentication message, UUAA result) is transmitted. Further, in a twelfth communication 436, an Nnef_auth_Resp (e.g., authentication message success or failure) is transmitted. Moreover, in a thirteenth communication 438, a PDU session establishment continues and completes.

In system 400, if a PDU session is requested, a successful UUAA allows PDU session establishment to provide UAS services for the UAV. But system 400 does not allow any other devices (e.g., like a blind assistance device) to connect or to get blind assistance services from the UAVs.

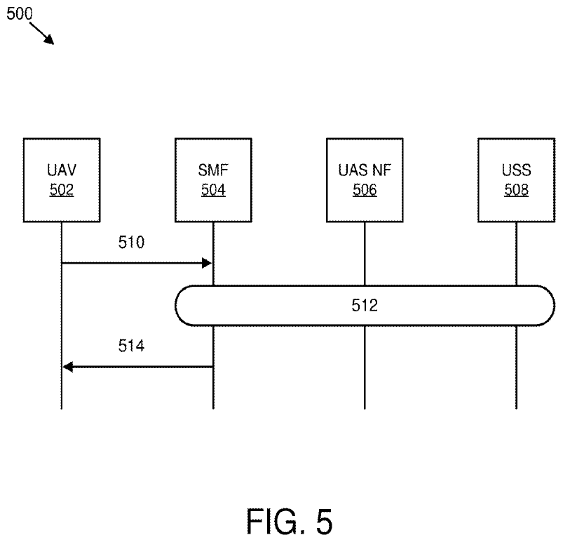

FIG. 5 illustrates an example of a system 500 that supports UAV pairing authorization during PDU session establishment in accordance with aspects of the present disclosure. The system 500 includes a UAV 502, an SMF 504, a UAS network function (“NF”) 506, and a USS 508. Each of the communications in the system 500 may include one or more messages.

In system 500, pairing authorization may be performed during the PDU session establishment and/or PDU session modification after a successful UAA between the UAV 502 and the USS 508 (e.g., USS/UTM). If no successful UUAA is performed, then the pairing authorization may occur during a UUAA-SM procedure.

In a first communication 510, a PDU session establishment request and/or PDU session modification request may be transmitted. The UAV 502 (e.g., UE) may include the following information elements (“IEs”) in the PDU session establishment and/or modification request: a CAA-Level UAV ID, a data network name (“DNN”) and/or single-network slice selection assistance information (“S-NSSAI”) (“DNN/S-NSSAI”) implying dedicated connectivity to UAV-C, and UAV pairing information, which includes any needed authorization information, if available. The pairing information includes the CAA-level UAV IDs of the requesting UAV 502 and identification information of UAV-C to pair. The USS 508 may use its locally configured pairing information for the UAV 502 and UAV-C pairing authorization which takes precedence over UAV 502 provided pairing information.

Moreover, in a second communication 512, there may be authorization with the USS 508. The SMF 504 determines whether UAV pairing authorization is required based on UAV's aerial subscription, presence of CAA-Level UAV ID, and DNN/S-NSSAI indicating the UAV service. Further, the SMF 504 invokes an authorization procedure with the USS 508 via the UAS NF 506. The USS 508 will perform C2 authorization taking account of the included pairing information, which includes any needed authorization information, if available, the CAA-Level UAV ID, and general public subscription identifier (“GPSI”). The USS 508 informs the SMF 504 via the UAS NF 506 of the authorization results. The authorization information includes the internet protocol (“IP”) address of the UAV-C and a C2 authorization payload that contains C2 session security information and possibly other non-security specific information (e.g., C2 authorization result) if the USS has such information to send.

Further, in a third communication 514, a PDU session establishment accept and/or PDU session modification command may be transmitted. The SMF 504 informs the UAV 502 the paring authorization result in the PDU session establishment accept message and/or PDU session modification command, which may include a new CAA-level UAV ID. The UAV 502 may store the pairing authorization result and authorization information. The PDU session establishment and/or modification continues and completes. The UAV 502 pairing authorization may be revoked by the USS 508 at any time. Further, the paired UAV-C may be replaced by a new UAV-C by the USS 508 at any time.

In the system 500, if a PDU session is requested related to C2 and/or pairing, a successful UUAA and C2 pairing authorization allows PDU session establishment to provide C2 services for the UAV 502 (e.g., related to the paired UAV-C). But the system 500 may not allow any other devices (e.g., like a blind assistance device) to connect or to get blind assistance service from UAVs.

Various embodiments are found herein that enable a blind assistance device (e.g., UE, a blind assistance service requestor) to be provided with a blind assistance service using a UAV (e.g., by pairing) or another UE (e.g., blind assistance service producer) pairing over a 3GPP network.

In a first embodiment, there may be a method to perform a UAV (e.g., blind) assistance service authorization by a USS. This may involve UAV U2B service and/or pairing authorization by a USS and/or UTM.

In a second embodiment, there may be a method to perform C2 and/or pairing authorization between a UAV and a blind Assistance UE (e.g., based on pre-configured pairing information). This may involve pre-configuration based UE and UAV pairing authorization (e.g., during PDU session establishment and/or modification procedure) by a USS and/or UTM.

In another embodiment, there may be a method to perform C2 and/or pairing authorization between a blind assistance UE and a UAV by a 3GPP network. This may involve target UAV and/or UE selection and related pairing authorization with a blind service assistance requestor UE.

In a further embodiment, there may be a method to perform C2 and/or pairing authorization between a blind assistance UE and a UAV by a USS. This may involve UE and UAV pairing authorization by a USS and/or UTM which covers options like target UAV selection by the network, selection by a USS and/or UTM, or pre-configuration as three options.

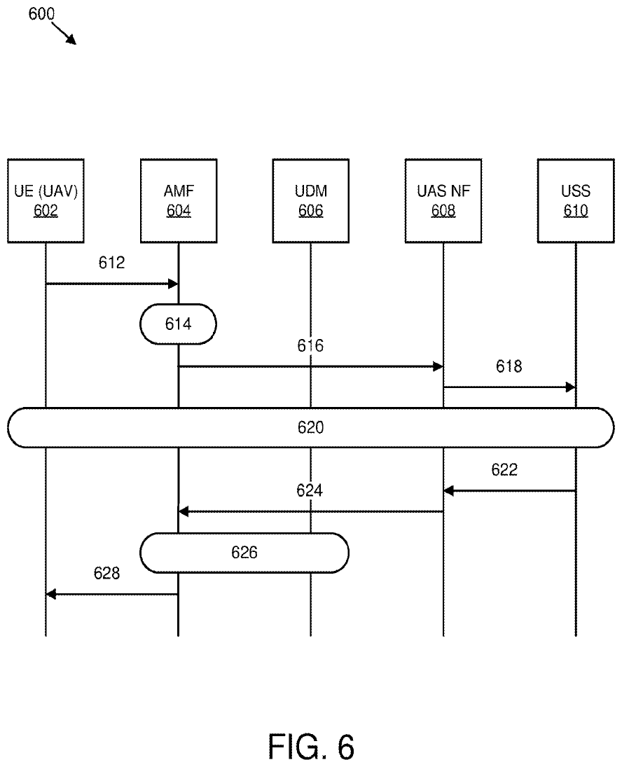

In the first embodiment, there may be a method to perform a UAV (e.g., blind) assistance service authorization by a USS. This embodiment describes how the UAV or UE's with an aerial subscription can be authorized to offer blind assistance and/or any assistance service to other UEs (e.g., a wearable device), where the UAV authorization to offer any assistance service (e.g., blind assistance service like aerial view-based voice assistance or blind mobility service assistance) and the related UAV-UE pairing authorization is performed by the USS and/or UTM via the 3GPP network. The blind assistance service authorization or pairing authorization procedure for the UAV-UE is shown in FIG. 6. The UAV blind and/or any service assistance authorization can be performed during the registration or PDU session establishment procedure.

FIG. 6 illustrates an example of a system 600 that supports UAV authorization by a USS and/or a UTM for blind assistance service provision over over a 3GPP network in accordance with aspects of the present disclosure. The system 600 includes a UE 602 (e.g., UAV), an AMF 604, a UDM 606, a UAS NF 608, and a USS 610. Each of the communications in the system 600 may include one or more messages.

In a first communication 612, the UE 602 sends, in a NAS message, the CAA-level UAV ID and an indication to indicate the UAV's capability to offer blind assistance service or the UAV's capability to offer mobility assistance service to any UE. The indication is referred to as U2B service capability. The NAS message may include a registration request or PDU session establishment request and/or PDU session modification request message.

If the first communication 612 is related to a PDU session establishment request message and/or a PDU session modification request message, then an SMF is involved instead of the AMF 604, and a session management message may be sent by SMF and forwarded by the AMF 604 to the UE 602 in an NAS message (e.g., NAS MM transport).

The AMF 604 may trigger 614 the UUAA procedure or the C2 and/or U2B service authorization if an aerial subscription is available for the UE 602.

In a second communication 616, the AMF 604 sends a message Nnef_Auth_Req (e.g., can be related to UUAA or C2 and/or U2B service authorization) to the UAS NF 608, including the UAV IDs (e.g., GPSI and/or the CAA-Level UAV ID, U2B service indication, and aviation payload if provided by the UE 702 for the USS 610 to authenticate the UE 602 (e.g., UAV). The AMF 604 may include other information in the second communication 616.

In a third communication 618, the UAS NF 608 resolves the USS 610 address based on the CAA-Level UAV ID or uses the provided USS 610 address. Only an authorized USS 610 is used to ensure only legitimate entities can provide authorization for UAVs. The UAS NF 608 sends an authentication request to the USS 610. The authentication request may include the UAV IDs (e.g., GPSI and/or the CAA-Level UAV ID), a U2B service indication, a UAS NF 608 routing information (e.g., a fully qualified domain name (“FQDN”) or IP address) which uniquely identifies the UAS NF 608 located in the 3GPP network that handles the UAV related message exchanges with the corresponding external USS 610 (or UTM), and the transparent container. Other information may also be included in this message if required.

In a fourth communication 620, the USS 610 and the UE 602 may exchange authentication messages. Multiple round-trip messages may be needed as required by the authentication method used by the USS 610. The USS 610 determines the authentication method used. The USS 610 replies to the UAS NF 608 with the authentication response message. It may include the GPSI and a transparent container including an authentication message. The UAS NF 608 sends the transparent container to the AMF 604 with the GPSI. Moreover, the AMF 604 forwards the transparent container to the UE 602 over NAS MM transport messages. The UE 602 responds to the AMF 604 with an authentication message embedded in a transparent container over a NAS MM transport message. Further, the AMF 604 sends a message Nnef_Auth_Req to the UAS NF 608, including the GPSI, the CAA-Level UAV ID, and the transparent container provided by the UE 602. Moreover, the UAS NF 608 sends an authentication request to the USS 610. The authentication request may include the GPSI, the CAA-Level UAV ID, and the transparent container.

The USS 610 (e.g., based on local policies, regulatory requirements, and any subscription information) determines if a UAV is allowed to offer or perform any assistance services (e.g., blind assistance services for other UEs over the 3GPP network and if the USS determines to allow such service offering it sends as U2B service and/or pairing allowed indication in or else it sends a U2B service and/or pairing not allowed (or rejected) indication.

In a fifth communication 622, the USS 610 sends to the UAS NF 608 an authentication response message. The authentication response may include the GPSI, the UUAA result (e.g., success or failure), the authorized CAA-level UAV ID, a U2B service and/or pairing allowed indication, and a UUAA authorization payload that contains UAS security information and a U2B service and/or pairing allowed indication if the USS 610 has this information to send.

In certain embodiments, based on USS 610 determinations, the fifth communication 622 may contain a U2B service and/or pairing not allowed or rejected indication.

The UAS NF 608 stores the GPSI, USS identifier (and the binding with the GPSI), U2B service and/or pairing allowed and/or not allowed indication (as received in the fifth communication 622), and the CAA-level UAV ID (and the binding with the GPSI). The USS identifier is used to ensure that a USS requesting a subsequent re-authentication or revocation is the same one that authenticated the UAV in the first place. The USS identifier is based on the security link on the interface between a USS NF and the USS 610 (e.g., the USS identity mapped during link establishment or the identity in a certificate).

In a sixth communication 624, the UAS NF 608 sends the AMF 604 an authentication response message, including the GPSI, the UUAA result (e.g., success and/or failure), the authorized CAA-level UAV ID, the U2B service and/or pairing allowed indication, and the UUAA authorization payload. In various embodiments, the sixth communication 624 may contain a U2B service and/or pairing not allowed or rejected indication.

In a seventh communication 626, in some embodiments, following a successful UUAA, the AMF 604 may check whether the U2B service is allowed (e.g., the UDM 606 manages U2B service authorization information (e.g., whether U2B is allowed) in addition to the aerial subscription information in the subscription data related to the UAV's subscription permanent identifier (“SUPI”) and/or GPSI for the UE 602. The UDM 606 may also manages, as part of U2B service authorization information, whether the UAV UE 602 can offer service to any specific UE 602 (e.g., identified by SUPI and/or GPSI), or a group of UEs (e.g., identified by SUPIs, GPSIs, internal group IDs, or external group IDs) or any random UEs in general.

In an eighth communication 628, the AMF 604 sends to the UE 602 the UUAA result (e.g., success and/or failure) and U2B service and/or pairing authorization result (e.g., allowed and/or not allowed) indication. The AMF 604 stores the results, U2B service and/or pairing allowed indication or U2B service and/or pairing not allowed and/or rejected indication, together with the GPSI and the CAA-level UAV ID.

If the UUAA result is successful, the AMF 604 sends to the UE 602 in any NAS MM transport the UUAA authorization payload (e.g., with U2B service, pairing allowed, not allowed, and/or rejected indication as determined and provided by the USS 610 (or UTM)), during a UE configuration update (“UCU”) procedure. The UE 702 may store the authorization information if received as UAS security information along with the CAA-level UAV ID.

The first embodiment is shown with a 5GS but can be applicable to EPS with the following NFs: an MME (e.g., instead of an AMF), a serving gateway (“SGW”), an SMF+PGW-C (e.g., instead of SMF), a PGW-U (e.g., instead of UPF), a home subscriber server (“HSS”) and/or an AuC (e.g., instead of UDM and/or UDR), and a NEF (e.g., instead of UAS NF).

In various embodiments, the UE 602 may be considered a blind assistance service provider UE and/or UAV. Therefore, the U2B service capability can be termed ‘U2B service provider capability’.

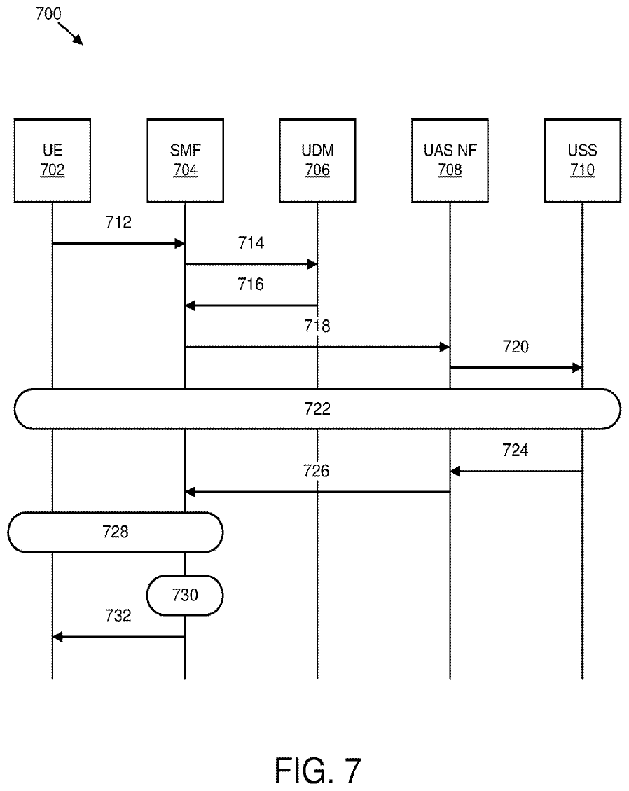

In the second embodiment, there may be a method to perform C2 and/or pairing authorization between a UAV and a blind assistance UE (e.g., based on pre-configured pairing information). This embodiment describes how the UAV preconfigured with target UE information (e.g., related to a blind assistance service UE (e.g., a wearable device)) to enable pairing of the UE (e.g., blind assistance UE) with the unmanned aerial vehicle (e.g., UAV or drone) based on the authorization from the USS and/or UTM to facilitate a blind assistance service (e.g., like aerial view-based voice assistance or blind mobility service assistance). One embodiment of a pairing authorization procedure for the UAV and the blind assistance UE is shown in FIG. 7.

In the second embodiment, the UAV is preconfigured with pairing information such as an associated blind assistance device UE's ID (e.g., a blind assistance service using a UAS and/or C2 service that needs to be offered to the UE). Its UE ID can be a GPSI and/or SUPI related to the UE. The UAV (which is also a UE) can also be configured with the UAV IDs which include the CAA-Level UAV ID and SUPI that has the related aerial subscription with the 3GPP network.

FIG. 7 illustrates an example of a system 700 that supports UE and UAV pairing authorization by a USS and/or a UTM for blind assistance service provision over a 3GPP network. The system 700 includes a UE 702 (e.g., UAV), an SMF 704, a UDM 706, a UAS NF 708, and a USS 710. Each of the communications in the system 700 may include one or more messages.

In a first communication 712, the UE 702 sends, in a NAS message, the CAA-level UAV ID and an indication to indicate the UAV's capability to offer blind assistance service or the UAV's capability to offer mobility assistance service to any UE. The indication is referred to as U2B service capability. Additionally, based on configuration, the UE 702 also includes a target UE ID such as SUPI and/or GPSI (e.g., related to the blind assistance device which need to be offered with blind assistance service by the UAV). The NAS message may include a registration request or PDU session establishment request and/or PDU session modification request message.

If the first communication 712 is related to a registration request, then an AMF may be involved instead of the SMF 704. A registration accept and/or reject message may be sent by the AMF to the UE 702 in an NAS message (e.g., NAS MM transport).

In a second communication 714 and a third communication 716, the SMF 704, if it received the U2B indication from the UE 702, fetches the service subscription data from the UDM 706 (e.g., by sending a request with a SUPI and receiving the subscription data in response with aerial subscription data, U2B service subscription data, and target blind device information). The SMF 704 may trigger the UUAA procedure or C2 and/or U2B service authorization if an aerial subscription and a U2B service capability and/or subscription information is available for the UE 702 and has a target blind assistance device ID (e.g., indicated with SUPI and/or GPSI of the related UE).

In a fourth communication 718, the SMF 704 sends a message Nnef_Auth_Req (e.g., can be related to UUAA or C2 and/or U2B service authorization) to the UAS NF 708, including the U2B service indication, UAV IDs (e.g., GPSI of UAV and the CAA-Level UAV ID), GPSI of the target UE, and the aviation payload if provided by the UE 702 for the USS 710 to authenticate and/or authorize the UAV. The SMF 704 may include other information in the request.

In a fifth communication 720, the UAS NF 708 resolves the USS 710 address based on the CAA-Level UAV ID or uses the provided USS 710 address. Only an authorized USS 710 is used to ensure only legitimate entities can provide authorization for UAVs. The UAS NF 708 sends an authentication and/or authorization request to the USS 710. The authentication and/or authorization request may include the UAV IDs (e.g., GPSI of UAV and/or the CAA-Level UAV ID), U2B service indication, GPSI of the target UE, and UAS NF 708 routing information (e.g., a fully qualified domain name (“FQDN”) or IP address) which uniquely identifies the UAS NF 708 located in the 3GPP network that handles the UAV related message exchanges with the corresponding external USS 710 (or UTM) and the transparent container. Other information may also be included in this message.

In a sixth communication 722, the USS 710 and the UE 702 may exchange authentication messages. Multiple round-trip messages may be needed as required by the authentication and/or authorization method used by the USS 710. The USS 710 determines the authentication method used. The USS 710 replies to the UAS NF 708 with the authentication and/or authorization response message. It may include the GPSI and a transparent container including an authentication and/or authorization message. The UAS NF 708 sends the transparent container to the SMF 704 with the GPSI. Moreover, the SMF 704 forwards the transparent container to the UE 702 over NAS MM transport messages. The UE 702 responds to the SMF 704 with an authentication message embedded in a transparent container over a NAS MM transport message. Further, the SMF 704 sends a message Nnef_Auth_Req to the UAS NF 708, including the GPSI of the UE 702, GPSI of target the UAV, the CAA-Level UAV ID, and the transparent container provided by the UE 702. Moreover, the UAS NF 708 sends an authentication and/or authorization request to the USS 710. The authentication and/or authorization request may include the GPSI of the UE 702, the CAA-Level UAV ID, and the transparent container.

The USS 710 (e.g., based on local policies, regulatory requirements, and any subscription information) determines if a UAV is allowed to offer or perform any assistance services (e.g., blind assistance services for other UEs over the 3GPP network and if the USS 710 determines to allow such service offering it sends as U2B service and/or pairing allowed indication or else it sends a U2B service and/or pairing not allowed (or rejected) indication.

In the seventh communication 724, the USS 710 sends to the UAS NF 708 an authentication and/or authorization response message. The authentication and/or authorization response may include the GPSI of the UE 702, the UUAA result (e.g., success or failure), the authorized CAA-level UAV ID, the U2B service and/or pairing allowed indication, the GPSI of the UE 702, and a UUAA Authorization and/or U2B authorization payload that contains UAS and/or U2B security information and U2B service and/or pairing allowed indication, and/or GPSI of the UE if the USS 710 has such information to send.

In certain embodiments, based on USS 710 determinations, the seventh communication 724 may contain U2B service and/or pairing not allowed or rejected indication. The UAS NF 708 stores the GPSI of the UE 702, GPSI of the UAV, a USS 710 identifier (and the binding with the GPSI), U2B service, pairing allowed, and/or not allowed indication and the CAA-level UAV ID (and the binding with the GPSI). The USS identifier is used to ensure that a USS requesting a subsequent re-authentication or revocation is the same one that authenticated the UAV in the first place. The USS identifier is based on the security link on the interface between a USS NF and the USS 710 (e.g., the identity mapped during link establishment or the identity in a certificate).

In an eighth communication 726, the UAS NF 708 sends the SMF 704 an authentication and/or authorization response message, including the GPSI of the UE 702, GPSI of the UAV, the UUAA and/or U2B authorization result (e.g., success or failure), the authorized CAA-level UAV ID, U2B service and/or pairing allowed indication, and the UUAA authorization payload. In various embodiments, the eighth communication 726 may contain a U2B service and/or pairing not allowed or rejected indication.

In a nineth communication 728, the SMF 704 performs established PDU session establishment and/or modification. The SMF 704 fetches the IP address related to the UAV (e.g., identified with GPSIs, CAA Level UAV IDs, and/or SUPI) and target UE ID based on the information locally available related to the target UE's context. Further, the SMF 704, based on the target UE's (e.g., the device which needs blind assistance service) IP address and UAV's IP address, pairing policy is configured 730 to allow data traffic (e.g., control and any signaling) in the PDU session between the UE 702 (e.g., blind assistance device) and a UAV by a UPF. The blind assistance device can also act like a UAV-C (e.g., the location of the blind assistance device (e.g., a blind person) drives the UAV to fly around the location of the blind assistance device and/or UE to provide aerial pictures and videos to assist in navigation of the blind person via the blind assistance device by providing blind assistance service over a 3GPP network).

In a tenth communication 732, the SMF 704 sends to the UE 702 the UUAA and/or U2B authorization result (e.g., success or failure) and U2B service and/or pairing authorization result (e.g., allowed or not allowed) indication. The SMF 704 stores the results, U2B service and/or pairing allowed indication or U2B service and/or pairing not allowed and/or rejected indication together with the GPSI of the UE 702, GPSI of UAV, and the CAA-level UAV ID.

If UUAA result is successful, the SMF 704 sends to the UE 702 in any session management (“SM”) transport via an AMF the UUAA authorization and/or U2B authorization payload (e.g., with U2B service and/or pairing allowed, not allowed, and/or rejected indication as determined and provided by the USS 710 (or UTM)) received in the Nsmf_PDUsession Create and/or update response message or PDU session establishment and/or modification accept message. The AMF forwards this to the UE 702 in the NAS message.

The UE 702 may store the authorization information if it received such as UAS and/or U2B security information along with the CAA-level UAV ID and GPSI of the target UE.

The second embodiment is shown with a 5GS but can be applicable to EPS with the following NFs: an MME (e.g., instead of an AMF), a serving gateway (“SGW”), an SMF+PGW-C (e.g., instead of SMF), a PGW-U (e.g., instead of UPF), a home subscriber server (“HSS”) and/or an AuC (e.g., instead of UDM and/or UDR), and a NEF (e.g., instead of UAS NF).

In various embodiments, the UE 602 may be considered a blind assistance service provider UE and/or UAV. Therefore, the U2B service capability can be termed ‘U2B service provider capability’. Further, the target UE ID (e.g., blind assistance device) the UAV UE provides may be considered as a target U2B service requestor ID.

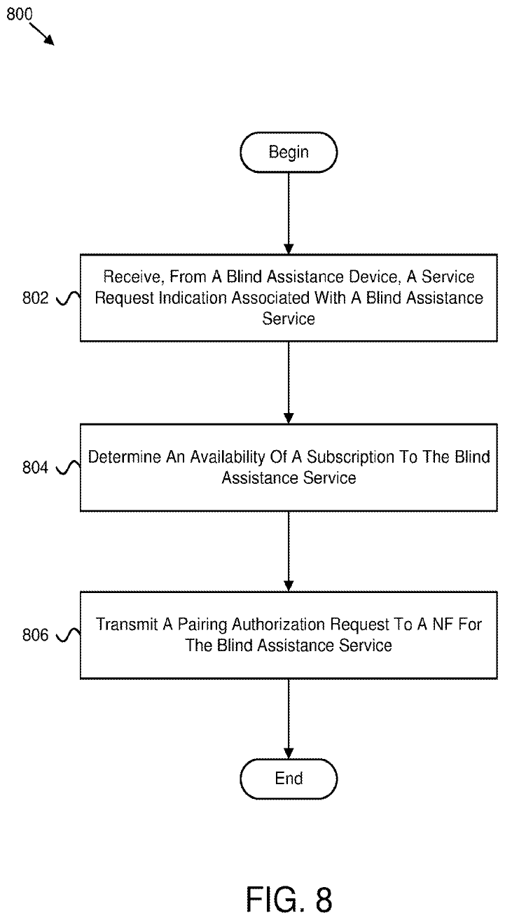

FIG. 8 illustrates a flowchart of a method 800 that supports wireless communications for providing a blind assistance service in accordance with aspects of the present disclosure. The operations of the method 800 may be implemented by an apparatus, such as a network unit 104 or its components as described herein. For example, the operations of the method 800 may be performed by a network unit 104 as described with reference to FIG. 1 through 7. Additionally, or alternatively, the operations of the method 800 may be performed by a processor executing program code, for example, a microcontroller, a microprocessor, a CPU, a GPU, an auxiliary processing unit, a FPGA, or the like.

In various embodiments, the method 800 includes receiving 802, from a blind assistance device, a service request indication associated with a blind assistance service. In some embodiments, the method 800 includes determining 804 an availability of a subscription to the blind assistance service. In certain embodiments, the method 800 includes transmitting 806 a pairing authorization request to a NF for the blind assistance service.

In certain embodiments, the method 800 further comprises receiving a pairing authorization response from the NF for the blind assistance service. In some embodiments, the method 800 further comprises transmitting, to the blind assistance device, a response to the service request indication, the response comprising a blind assistance service authorization result. In various embodiments, the service request indication comprises a U2B assistance service capability indication, a target blind assistance service consumer UE ID, or a combination thereof.

In one embodiment, the U2B service capability indication indicates that the blind assistance device has a blind assistance service producer capability, an UAV to blind assistance device pairing authorization is required, or a combination thereof. In certain embodiments, the method 800 further comprises determining the availability of the subscription to the blind assistance service for a SUPI of the blind assistance device in a UDM, UDR, or a combination thereof. In some embodiments, the method 800 further comprises transmitting the pairing authorization request to the NF for the blind assistance service with a U2B assistance service type indication, an UAV ID, a GPSI of a UAV, a GPSI of a target UE, or any combination thereof.

In various embodiments, the method 800 further comprises receiving a pairing authorization response from the NF for the blind assistance service with an authorized UAV ID, an authorized GPSI of a UAV, an authorized GPSI of a target UE, a U2B assistance service paring allowed indication, a U2B service pairing not allowed indication, or any combination thereof. In one embodiment, the core network device comprises SMF, and the method further comprises, in response to receiving the U2B service paring allowed indication, performing a PDU session establishment, a PDU session modification, or a combination thereof. In certain embodiments, the method 800 further comprises configuring a pairing policy to allow traffic between the UAV and the target UE based on their respective IP addresses.

In some embodiments, the blind assistance device comprises a UE. In various embodiments, the core network device comprises an AMF, a SMF, or a combination thereof. In one embodiment, the NF comprises an UAS, a NEF, or a combination thereof.

In certain embodiments, the NF transmits the pairing authorization request to an USS, an UTM, or a combination thereof. In some embodiments, the NF receives a pairing authorization response from the USS, the UTM, or the combination thereof.

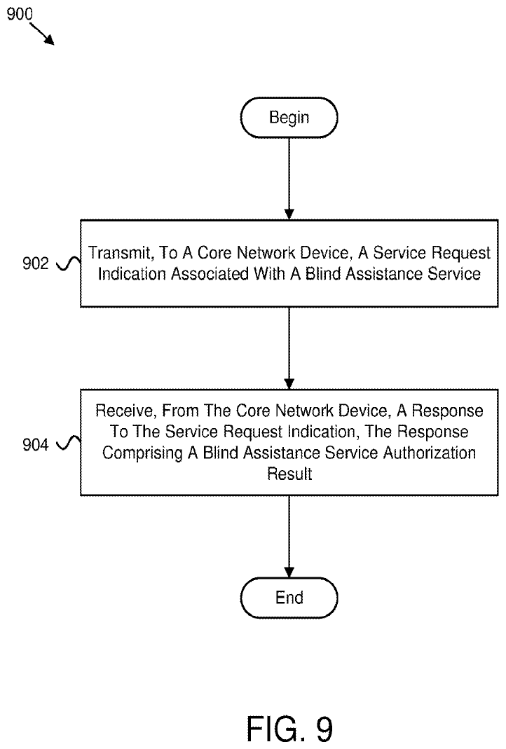

FIG. 9 is a flowchart of a method 900 that supports wireless communications for providing a blind assistance service in accordance with aspects of the present disclosure. The operations of the method 900 may be implemented by an apparatus, such as a remote unit 102 or its components as described herein. For example, the operations of the method 900 may be performed by a remote unit 102 as described with reference to FIG. 1 through 7. Additionally, or alternatively, the operations of the method 900 may be performed by a processor executing program code, for example, a microcontroller, a microprocessor, a CPU, a GPU, an auxiliary processing unit, a FPGA, or the like.

In various embodiments, the method 900 includes transmitting 902, to a core network device, a service request indication associated with a blind assistance service. In some embodiments, the method 900 includes receiving 904, from the core network device, a response to the service request indication, the response including a blind assistance service authorization result.

In certain embodiments, the service request indication comprises U2B assistance service capability indication, a target blind assistance service consumer UE ID, or a combination thereof. In some embodiments, the U2B service capability indication indicates that the blind assistance device has a blind assistance service producer capability, an UAV to blind assistance device pairing authorization is required, or a combination thereof.

In various embodiments, the blind assistance device comprises a UE. In one embodiment, the core network device comprises an AMF, a SMF, or a combination thereof.

In one embodiment, an apparatus for wireless communication, the apparatus comprising: a processor; and a memory coupled to the processor, the memory comprising instructions executable by the processor to cause the apparatus to: receive, from a blind assistance device, a service request indication associated with a blind assistance service; determine an availability of a subscription to the blind assistance service; and transmit a pairing authorization request to a NF for the blind assistance service.

In certain embodiments, the instructions are further executable by the processor to cause the apparatus to receive a pairing authorization response from the NF for the blind assistance service.

In some embodiments, the instructions are further executable by the processor to cause the apparatus to transmit, to the blind assistance device, a response to the service request indication, the response comprising a blind assistance service authorization result.

In various embodiments, the service request indication comprises U2B assistance service capability indication, a target blind assistance service consumer UE ID, or a combination thereof.

In one embodiment, the U2B service capability indication indicates that the blind assistance device has a blind assistance service producer capability, an UAV to blind assistance device pairing authorization is required, or a combination thereof.

In certain embodiments, the instructions are further executable by the processor to cause the apparatus to determine the availability of the subscription to the blind assistance service for a SUPI of the blind assistance device in a UDM, UDR, or a combination thereof.

In some embodiments, the instructions are further executable by the processor to cause the apparatus to transmit the pairing authorization request to the NF for the blind assistance service with a U2B assistance service type indication, an UAV ID, a GPSI of a UAV, a GPSI of a target UE, or any combination thereof.

In various embodiments, the instructions are further executable by the processor to cause the apparatus to receive a pairing authorization response from the NF for the blind assistance service with an authorized UAV ID, an authorized GPSI of a UAV, an authorized GPSI of a target UE, a U2B assistance service paring allowed indication, a U2B service pairing not allowed indication, or any combination thereof.

In one embodiment, the apparatus comprises SMF, and the instructions are further executable by the processor to cause the apparatus to, in response to receiving the U2B service paring allowed indication, perform a PDU session establishment, a PDU session modification, or a combination thereof.

In certain embodiments, the instructions are further executable by the processor to cause the apparatus to configure a pairing policy to allow traffic between the UAV and the target UE based on their respective IP addresses.

In some embodiments, the blind assistance device comprises a UE.

In various embodiments, the apparatus comprises an AMF, a SMF, or a combination thereof.

In one embodiment, the NF comprises an UAS, a NEF, or a combination thereof.

In certain embodiments, the NF transmits the pairing authorization request to an USS, an UTM, or a combination thereof.

In some embodiments, the NF receives a pairing authorization response from the USS, the UTM, or the combination thereof.

In one embodiment, a method at a core network device for wireless communication, the method comprising: receiving, from a blind assistance device, a service request indication associated with a blind assistance service; determining an availability of a subscription to the blind assistance service; and transmitting a pairing authorization request to a NF for the blind assistance service.

In certain embodiments, the method further comprises receiving a pairing authorization response from the NF for the blind assistance service.

In some embodiments, the method further comprises transmitting, to the blind assistance device, a response to the service request indication, the response comprising a blind assistance service authorization result.

In various embodiments, the service request indication comprises a U2B assistance service capability indication, a target blind assistance service consumer UE ID, or a combination thereof.

In one embodiment, the U2B service capability indication indicates that the blind assistance device has a blind assistance service producer capability, an UAV to blind assistance device pairing authorization is required, or a combination thereof.

In certain embodiments, the method further comprises determining the availability of the subscription to the blind assistance service for a SUPI of the blind assistance device in a UDM, UDR, or a combination thereof.

In some embodiments, the method further comprises transmitting the pairing authorization request to the NF for the blind assistance service with a U2B assistance service type indication, an UAV ID, a GPSI of a UAV, a GPSI of a target UE, or any combination thereof.

In various embodiments, the method further comprises receiving a pairing authorization response from the NF for the blind assistance service with an authorized UAV ID, an authorized GPSI of a UAV, an authorized GPSI of a target UE, a U2B assistance service paring allowed indication, a U2B service pairing not allowed indication, or any combination thereof.

In one embodiment, the core network device comprises SMF, and the method further comprises, in response to receiving the U2B service paring allowed indication, performing a PDU session establishment, a PDU session modification, or a combination thereof.

In certain embodiments, the method further comprises configuring a pairing policy to allow traffic between the UAV and the target UE based on their respective IP addresses.

In some embodiments, the blind assistance device comprises a UE.

In various embodiments, the core network device comprises an AMF, a SMF, or a combination thereof.

In one embodiment, the NF comprises an UAS, a NEF, or a combination thereof.

In certain embodiments, the NF transmits the pairing authorization request to an USS, an UTM, or a combination thereof.

In some embodiments, the NF receives a pairing authorization response from the USS, the UTM, or the combination thereof.

In one embodiment, an apparatus for wireless communication, the apparatus comprising: a processor; and a memory coupled to the processor, the memory comprising instructions executable by the processor to cause the apparatus to: transmit, to a core network device, a service request indication associated with a blind assistance service; and receive, from the core network device, a response to the service request indication, the response comprising a blind assistance service authorization result.

In certain embodiments, the service request indication comprises a U2B assistance service capability indication, a target blind assistance service consumer UE ID, or a combination thereof.

In some embodiments, the U2B service capability indication indicates that the apparatus has a blind assistance service producer capability, an UAV to blind assistance device pairing authorization is required, or a combination thereof.

In various embodiments, the apparatus comprises a blind assistance device.

In one embodiment, the blind assistance device comprises a UE.

In certain embodiments, the core network device comprises an AMF, a SMF, or a combination thereof.

In one embodiment, a method at a blind assistance device for wireless communication, the method comprising: transmitting, to a core network device, a service request indication associated with a blind assistance service; and receiving, from the core network device, a response to the service request indication, the response comprising a blind assistance service authorization result.

In certain embodiments, the service request indication comprises U2B assistance service capability indication, a target blind assistance service consumer UE ID, or a combination thereof.

In some embodiments, the U2B service capability indication indicates that the blind assistance device has a blind assistance service producer capability, an UAV to blind assistance device pairing authorization is required, or a combination thereof.

In various embodiments, the blind assistance device comprises a UE.

In one embodiment, the core network device comprises an AMF, a SMF, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

1. An apparatus for performing a network function (NF), the apparatus comprising:
at least one memory; and
at least one processor coupled with the at least one memory and configured to cause the apparatus to:
receive, from a blind assistance device, a service request indication associated with a blind assistance service;
determine an availability of a subscription to the blind assistance service; and
transmit a pairing authorization request to the NF for the blind assistance service.

2. The apparatus of claim 1, wherein the at least one processor is configured to cause the apparatus to receive a pairing authorization response from the NF for the blind assistance service.

3. The apparatus of claim 2, wherein the at least one processor is configured to cause the apparatus to transmit, to the blind assistance device, a response to the service request indication, the response comprising a blind assistance service authorization result.

4. The apparatus of claim 1, wherein the service request indication comprises a user equipment (UE)-to-blind (U2B) assistance service capability indication, or a target blind assistance service consumer UE ID, or both.

5. The apparatus of claim 4, wherein the U2B assistance service capability indication indicates that the blind assistance device has a blind assistance service producer capability, or an uncrewed aerial vehicle (UAV) to blind assistance device pairing authorization is required, or both.

6. The apparatus of claim 1, wherein the at least one processor is configured to cause the apparatus to determine the availability of the subscription to the blind assistance service for a subscription permanent identifier (SUPI) of the blind assistance device in a unified data management (UDM), or unified data repository (UDR), or both.

7. The apparatus of claim 1, wherein the at least one processor is configured to cause the apparatus to transmit the pairing authorization request to the NF for the blind assistance service with one or more of a user equipment (UE)-to-blind (U2B) assistance service type indication, an uncrewed aerial vehicle (UAV) identifier (ID), a general public subscription identifier (GPSI) of a UAV, or a GPSI of a target UE.

8. The apparatus of claim 1, wherein the at least one processor is configured to cause the apparatus to receive a pairing authorization response from the NF for the blind assistance service with one or more of an authorized uncrewed aerial vehicle (UAV) identifier (ID), an authorized general public subscription identifier (GPSI) of a UAV, an authorized GPSI of a target UE, a user equipment (UE)-to-blind (U2B) assistance service paring allowed indication, or a U2B service pairing not allowed indication.

9. The apparatus of claim 8, further comprising a session management function (SMF), wherein the at least one processor is configured to cause the apparatus to, in response to receiving the U2B service paring allowed indication, perform a protocol data unit (PDU) session establishment, or a PDU session modification, or both.

10. The apparatus of claim 9, wherein the at least one processor is configured to cause the apparatus to configure a pairing policy to allow traffic between the UAV and the target UE based on their respective internet protocol (IP) addresses.

11. The apparatus of claim 1, wherein the blind assistance device comprises a user equipment (UE).

12. The apparatus of claim 1, further comprising an access and mobility management function (AMF), or a session management function (SMF), or both.

13. The apparatus of claim 1, wherein the NF comprises an uncrewed aerial system (UAS), or a network exposure function (NEF), or both.

14. The apparatus of claim 1, wherein the NF transmits the pairing authorization request to an uncrewed aerial system (UAS) service supplier (USS), or an uncrewed aerial system traffic management (UTM), or both.

15. The apparatus of claim 14, wherein the NF receives a pairing authorization response from the USS, or the UTM, or both.

16. A user equipment (UE), comprising:
at least one memory; and
at least one processor coupled with the at least one memory and configured to cause the UE to:
transmit, to a core network device, a service request indication associated with a blind assistance service; and
receive, from the core network device, a response to the service request indication, the response comprising a blind assistance service authorization result.

17. The UE of claim 16, wherein the service request indication comprises a user equipment (UE)-to-blind (U2B) assistance service capability indication, or a target blind assistance service consumer UE ID, or both.

18. The UE of claim 17, wherein the U2B assistance service capability indication indicates that the UE has a blind assistance service producer capability, or an uncrewed aerial vehicle (UAV) to blind assistance device pairing authorization is required, or both.

19. A processor for wireless communication, comprising:
at least one controller coupled with at least one memory and configured to cause the processor to:
transmit, to a core network device, a service request indication associated with a blind assistance service; and
receive, from the core network device, a response to the service request indication, the response comprising a blind assistance service authorization result.

20. A method performed by a user equipment (UE), the method comprising:
transmitting, to a core network device, a service request indication associated with a blind assistance service; and
receiving, from the core network device, a response to the service request indication, the response comprising a blind assistance service authorization result.
